(19) United States
(12) Patent Application Publication
(10) Pub. No.: US 2020/0109950 A1
(43) Pub. Date: Apr. 9, 2020

(54) SHIP NAVIGATION SYSTEM AND METHOD THEREOF

(71) Applicant: INSTITUTE FOR INFORMATION INDUSTRY, TAIPEI (TW)

(72) Inventors: Shih-Sian JHUANG, Taipei City (TW); Jui-Yang TSAI, New Taipei City (TW); Chih-Min SHIH, New Taipei City (TW); Wen-Kai LIU, Taipei City (TW)

(21) Appl. No.: 16/182,577

(22) Filed: Nov. 6, 2018

(30) Foreign Application Priority Data
Oct. 8, 2018 (TW) 107135444

(51) Int. Cl. G01C 21/20; B63B 49/00

(52) U.S. Cl. CPC G01C 21/203; B63B 49/00

(57) ABSTRACT

A ship navigation system includes a memory and a processor. The memory stores instructions. The processor is configured to access the instructions to perform the following: receiving a start point and a terminal point of a target ship in a marine area; receiving real-time environmental information of the marine area; receiving historical shipping lanes of the marine area and historical environmental information corresponding to the historical shipping lanes and; comparing historical environmental information and real-time environmental information to select a target lane leading from a location near the start point to a location near the terminal point; and connecting the start point and the terminal point with the target lane to generate an recommended lane for the target ship in the marine area.

### CROSS-REFERENCE TO RELATED APPLICATION

This application claims priority to Taiwan Application Serial Number 107135444, filed on Oct. 8, 2018, which is herein incorporated by reference.

### BACKGROUND

### Field of Invention

Present disclosure relates to a navigation system and a navigation method. More particularly, present disclosure relates to a navigation system and a navigation method for ships.

### Description of Related Art

In conventional arts, A* search algorithms are widely used in marine navigation. The known A* search algorithms can be used to find a shortest path for a ship to get away from obstacles (e.g. lands or islands). However, A* search algorithms being used in conventional arts can sometimes provide lanes that are closed to shores. The A* search algorithms being used in conventional arts can also provide unideal lanes that are restricted by obstacles. Therefore, improvements to current navigation systems are required.

### SUMMARY

An aspect of present disclosure relates to a ship navigation system. The ship navigation system comprises a memory and a processor. The memory is configured to store at least one instruction. The processor is coupled to the memory. The processor is configured to access the at least one instruction to perform the following operations: receiving a start point of a target ship and a terminal point of the target ship in a marine area; receiving real-time environmental data of the marine area, a plurality of historical lanes in the marine area and historical environmental data corresponding to the plurality of historical lanes; comparing the historical environmental data with the real-time environmental data to select a target lane from the historical lanes, wherein the target lane is leading from a location near the start point to a location near the terminal point; and connecting the start point and the terminal point with the target lane to generate an recommended lane for the target ship in the marine area.

Another aspect of disclosure relates to a ship navigation method. The ship navigation method is performed by a processor according to at least one instruction accessed from a memory. The ship navigation method comprising: receiving a start point of a target ship and a terminal point of the target ship in a marine area; receiving real-time environmental data of the marine area, a plurality of historical lanes in the marine area and historical environmental data corresponding to the plurality of historical lanes; comparing the historical environmental data with the real-time environmental data to select a target lane from the historical lanes, wherein the target lane is leading from a location near the start point to a location near the terminal point; and connecting the start point and the terminal point with the target lane to generate an recommended lane for the target ship in the marine area.

In some embodiments, the processor is further configured to access the at least one instruction to perform following steps: receiving a real-time position and a direction of a plurality of surrounding ships in the marine area; estimating whether the recommended lane is blocked by the plurality of surrounding ships according to the real-time positions and the directions of the plurality of surrounding ships; and in response to the recommended lane being estimated to be blocked by the plurality of surrounding ships, modifying the recommended lane to a modified lane.

In some embodiments, the processor estimating whether the recommended lane is blocked by the plurality of surrounding ships according to the real-time positions and the directions of the plurality of surrounding ships further comprising: extending a safety distance from the real-time positions of the plurality of surrounding ships, in order to generate a plurality of obstacle zones according to the directions of the plurality of surrounding ships; estimating whether the recommended lane encounters the plurality of obstacle zones; and in response to the recommended lane being estimated to encounter the plurality of obstacle zones, determining that the recommended lane is blocked by the plurality of surrounding ships.

In some embodiments, the processor comparing the historical environmental data with the real-time environmental data to select the target lane from the historical lanes further comprising: calculating a plurality of difference levels between the historical environmental data corresponding to each of the historical lanes and the real-time environmental data, in order to select at least one first candidate lane from the historical lanes according to the plurality of difference levels; and selecting the target lane from the at least one first candidate lane.

In some embodiments, the processor calculating the plurality of difference levels to select the at least one first candidate lane further comprising: selecting a first lane from the historical lanes; obtaining a historical parameter set from the historical environmental data corresponding to the first lane and obtaining a real-time parameter set from the real-time environmental data corresponding to the historical parameter set; calculating a difference between the real-time parameter set and the historical parameter set corresponding to the first lane; determining whether the difference corresponding to the first lane exceeds a predetermined threshold; if the difference corresponding to the first lane is determined to exceed the predetermined threshold, removing the first lane from the historical lanes; and if the difference corresponding to the first lane is determined not to exceed the predetermined threshold, selecting the first lane to be the at least one first candidate lane.

In some embodiments, the processor selecting the target lane from the at least one first candidate lane further comprising: counting a plurality of way points corresponding to each of the at least one first candidate lane; selecting the at least one first candidate lane having the least way points and determining whether a number of the at least one first candidate lane being selected exceeds one; and if the number of the at least one first candidate lane being selected is determined not to exceed one, confirming that the at least one first candidate lane being selected to be the target lane.

In some embodiments, if the number of the at least one first candidate lane being selected is determined to exceed one, the processor is further configured to access the at least one instruction to perform the following: selecting the at least one first candidate lane having the least way points to be a plurality of second candidate lanes; depicting a selection frame in the marine area, wherein the start point of the target ship and the terminal point of the target ship are located at two corners of the selection frame respectively; targeting a first intersection and a second intersection that each of the plurality of second candidate lanes crossing the selection frame; calculating a first distance between the first intersection and the start point and a second distance between the second intersection and the terminal point; calculating a sum of the first distance and the second distance corresponding to each of the plurality of second candidate lanes; and selecting a second lane from the plurality of second candidate lanes, wherein the sum of the second lane is the least among the plurality of second candidate lanes.

In some embodiments, the historical parameter set comprises at least one of a wind direction, a wind speed, a current direction and a current speed, and the real-time parameter set comprises at least one of the wind direction, the wind speed, the current direction and the current speed.

In some embodiments, the processor generating the recommended lane for the target ship in the marine area further comprising: connecting a lead-in lane from the start point to the target lane; connecting a lead-out lane from the target lane to the terminal point; and applying a curve fitting process to the lead-in lane, the lead-out lane and the target lane to generate the recommended lane.

According to above aspects and embodiments, the ship navigation system and the ship navigation method can be used to select one of the historical lanes according to the real-time environmental data and the historical environmental data, and connect the selected historical to the start point and the terminal point of the target ship to gain the recommended lane. The recommended lane generated according to present disclosure can be safely kept away from the shore. In this manner, an efficient navigation process can be provided.

### BRIEF DESCRIPTION OF THE DRAWINGS

FIG. 1 is a schematic diagram illustrating a ship navigation system according to one embodiment of present disclosure;

FIG. 2 is a flow chart illustrating a ship navigation method according to one embodiment of present disclosure;

FIG. 3 is a schematic diagram illustrating part of the navigation method according to one embodiment of present disclosure;

FIG. 4 is a schematic diagram illustrating part of the navigation method according to one embodiment of present disclosure;

FIG. 5 is a schematic diagram illustrating part of the navigation method according to one embodiment of present disclosure;

FIG. 6 is a schematic diagram illustrating a comparison between shipping lanes according to one embodiment of present disclosure;

FIG. 7 is a schematic diagram illustrating part of the navigation method according to one embodiment of present disclosure;

FIG. 8 is a schematic diagram illustrating a comparison between shipping lanes according to one embodiment of present disclosure;

FIG. 9 is a schematic diagram illustrating part of the navigation method according to one embodiment of present disclosure;

FIG. 10 is a schematic diagram illustrating part of the navigation method according to one embodiment of present disclosure;

FIG. 11 is a schematic diagram illustrating part of the navigation method according to one embodiment of present disclosure;

FIG. 12 is a schematic diagram illustrating part of the navigation method according to one embodiment of present disclosure;

FIG. 13 is a schematic diagram illustrating part of the navigation method according to one embodiment of present disclosure; and

FIG. 14 is a schematic diagram illustrating part of the navigation method according to one embodiment of present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In the following description and claims, unit being described with singulars, such as “one”, “the”, “that”, and “this” are not intend to limited the numbers of the described unit.

In the following description and claims, the terms “first”, “second”, and the like are not intend to limit a specific order of the units being described.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

As used herein, the terms “comprising,” “including,” “having,” and the like are to be understood to be open-ended, i.e., to mean including but not limited to.

In the following description and claims, the term “and/or” may be used to describe one of a plurality things or a combination or said things.

In the following description and claims, some of the directions “up”, “down”, “before, “after” and the like can be considered as references along with the figures. The scope of present disclosure should not be limited thereto.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

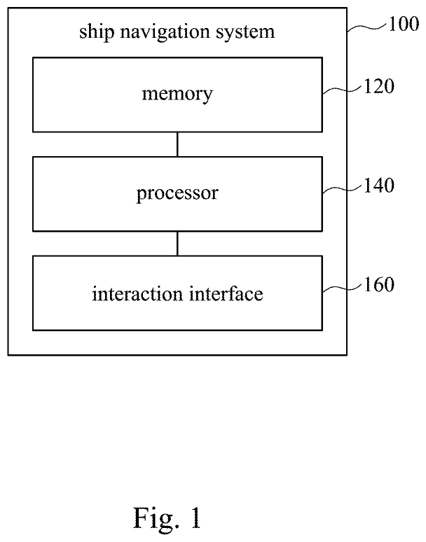

FIG. 1 is a schematic diagram illustrating a ship navigation system according to one embodiment of present disclosure. As shown in FIG. 1, in the embodiment, a ship navigation system 100 at least includes a memory 120 and a processor 140. The memory 120 is communicatively or electrically coupled to the processor 140. In some embodiment, processor 140 includes, but not limited to, a single processor and an integration of multiple microprocessors. The single processor or the integration of multiple microprocessors can be electrically coupled to the memory 120. The memory 120 can be internal memory or external memory, which can be volatile or non-volatile. In the embodiment, processor 140 can access at least one instruction form the memory 120 and execute the at least one instruction to perform some applications determined by the at least one instruction. For better understandings, the applications determined by the at least one instruction will be introduced in following paragraphs. In some embodiments, the processor 140 can be an application-specific integrated circuit. It is noted that the embodiments of the processor 140 are for exemplary purpose, other possible alternatives are in cover of the scope of present disclosure.

In some embodiments, except the at least one instruction, the memory 120 can store (or temporarily store) other necessary data for the processor 140 to perform the applications, or store (or temporarily store) data generated by the processor 140 in such applications.

As shown in FIG. 1, in some embodiments, the ship navigation system 100 can include an interaction interface 160. The interaction interface 160 is communicatively or electrically coupled to the processor 140. In some embodiments, the interaction interface 160 includes an input interface (not shown), such as keyboards, microphones, mice or touch displays, etc. Users can input information via such input interface. The interaction interface 160 can transform the information being inputted by the users to electric signals and send the electric signals to the processor 140. In some embodiments, the interaction interface 160 includes an output interface (not shown), such as displays, speakers or printers etc. The interaction interface 160 can receive electric signals sent from the processor 140. The output interface can present information corresponding to the electric signals through images, sounds, texts or lists, etc.

In some embodiments, the ship navigation system 100 is settled on a ship. The ship can be a large vessel such as a battle ship, a cruise, or a ferry. The ship can be a small ship such as a fishing ship or a motor boat. The ship can also be an automated ship such as an automated observing ship or an automated patrol ship. In some embodiments, the ship navigation system 100 is not settled on a ship but communicatively coupled to some electrical devices on the ship. The ship navigation system 100 can apply unidirectional or bidirectional information transmission with the electrical devices on the ship. Therefore, in these embodiments, the ship navigation system 100 can determine a recommended lane for the ship in some marine areas, which is, to navigate the ship in these marine areas.

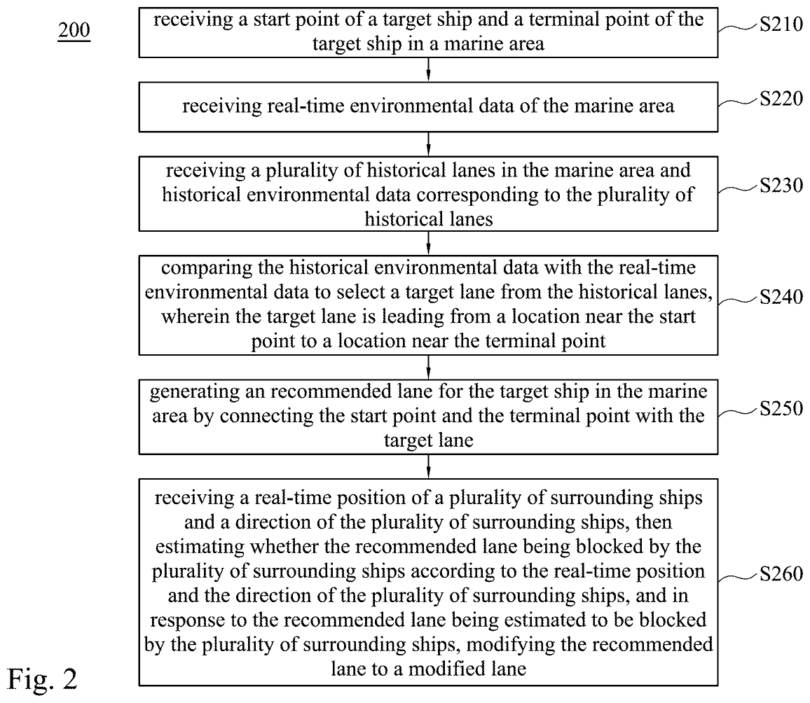

FIG. 2 is a flow chart illustrating a ship navigation method according to one embodiment of present disclosure. In the embodiment, the ship navigation method 200 can be performed by the ship navigation system 100 shown in the embodiment of FIG. 1. In particular, in the embodiment shown in FIG. 1, the memory 120 stores the at least one instruction associated with the ship navigation method 200 shown in FIG. 2. The processor 140 can access the at least one instruction from the memory 120 and perform the navigation method 200 determined by the at least one instruction. The navigation method 200 can be used to find a recommended lane for a target ship in a marine area. In the embodiment, steps of the ship navigation method 200 will be explained in following paragraphs.

In step S210: receiving a start point of a target ship and a terminal point of the target ship in a marine area.

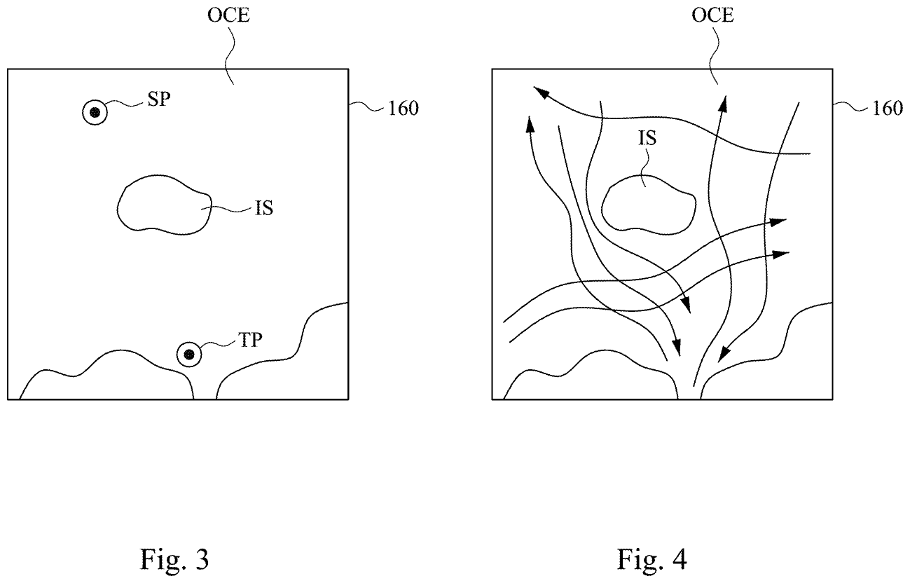

In some embodiments, the ship navigation system 100 includes the interaction interface 160. The processor 140 can access a map of the marine area from the memory 120. The processor 140 can send the map to the interaction interface 160 thereon the map of the marine area is displayed. For better understandings, reference is made to FIG. 3. FIG. 3 is a schematic diagram illustrating part of the navigation method according to one embodiment of present disclosure. As shown in FIG. 3, the interaction interface 160 can visually display regions of lands, waters, and islands in that marine area OCE.

In some embodiments, the users can enter a start point SP of the target ship and a terminal point TP of the target ship in the marine area OCE via the input interface (e.g. touch display) of the interaction interface 160. As shown in FIG. 3, the start point SP is settled around the upper-left of the marine area OCE and the terminal point TP is settled around a harbor located at the land in the marine area OCE. There is an island IS blocks a direct path from the start point SP to the terminal point TP in this marine area OCE.

In some embodiments, the users can enter the start point SP of the target ship and the terminal point TP of the target ship in the marine area OCE via the input interface (e.g. keyboards) of the interaction interface 160. For instance, the users can input longitudes and latitudes of the start point SP and the terminal point TP, and the output interface of the interaction interface 160 can display the positions of the start point SP and the terminal point TP in the marine area OCE.

In some embodiments, the start point SP of the target ship and the terminal point TP of the target ship in the marine area OCE has being stored in the memory 120 in advance, the processor 140 can access the start point SP of the target ship and the terminal point TP of the target ship from the memory 120. The processor 140 can further send the map of the marine area OCE, the start point SP of the target ship and the terminal point TP of the target ship to the interaction interface 160, and the interaction interface 160 can display the map of the marine area OCE, the start point SP of the target ship and the terminal point TP of the target ship via the output interface.

In step S220: receiving real-time environmental data of the marine area.

In some embodiments, the ship navigation system 100 can be communicatively coupled to a weather server (not shown). In this case, the processor 140 of the ship navigation system 100 can obtain real-time environmental data in the marine area OCE from the weather server. It is noted that the real-time environmental data here refer to some environmental parameters that can possibly influence ship sailings, such as wind directions, wind speeds, current directions and current speeds in every sub areas of the marine area OCE.

In step S230: receiving a plurality of historical lanes in the marine area and historical environmental data corresponding to the plurality of historical lanes.

In some embodiments, the ship navigation system 100 can be communicatively coupled to a ship management server (not shown). The ship management server is communicatively coupled to automatic identification systems (AIS) of a plurality of ships in the marine area OCE to collect data of these ships around the target ship. Said data can be identification codes, names, positions, directions, speed, and captains of these ships. In this case, the processor 140 of the ship navigation system 100 can obtain the data of other ships in the marine area OCE from the ship management server. It is noted that a method for the ship navigation system 100 to retrieve the data from the automatic identification systems is known to person skilled in the art thus it would not be discussed in this document.

As mentioned, the ship management server is communicatively coupled to the automatic identification systems settled on the ships in the marine area OCE in order to collect data of the ships, including positions, directions, and speeds. By accumulating the collected data, the ship management server can obtain lane of the ships in the marine area OCE, so called the historical lanes of the ships in the marine area OCE.

Similarly, the weather server can retrieve the real-time environmental data in the marine area OCE, including wind directions, wind speeds, current directions and current speeds in every sub areas of the marine area OCE. By accumulating the collected data, the weather server can obtain long-term environmental data in the marine area OCE, so called the historical environmental data of the marine area OCE.

In some embodiments, the ship navigation system 100 can be communicatively coupled to the ship management server and the weather server to retrieve the historical lanes of the ships in the marine area OCE and the historical environmental data in the marine area OCE. In some embodiments, the processor 140 of the ship navigation system 100 can send electrical signal carrying said data to the interaction interface 160, and the interaction interface 160 can output said data via the output interface. For example, the interaction interface 160 can display the historical lanes of the ships in the marine area OCE and the historical environmental data in the marine area OCE on the map of the marine area OCE. For better understanding, reference is made to FIG. 4. FIG. 4 is a schematic diagram illustrating part of the navigation method according to one embodiment of present disclosure. In some embodiments, the interaction interface 160 can display the historical lanes of the ships and the historical environmental data on the map of the marine area OCE. As shown in FIG. 4, via the interaction interface 160, some historical lanes of the ships are shown on the map of marine area OCE. In some embodiments, the input interface of the interaction interface 160 can be used by the users to select some of the historical lanes, and the interaction interface 160 can display further information of the selected historical lanes in some information blocks.

In step S240: comparing the historical environmental data with the real-time environmental data to select a target lane from the historical lanes, wherein the target lane is leading from a location near the start point to a location near the terminal point.

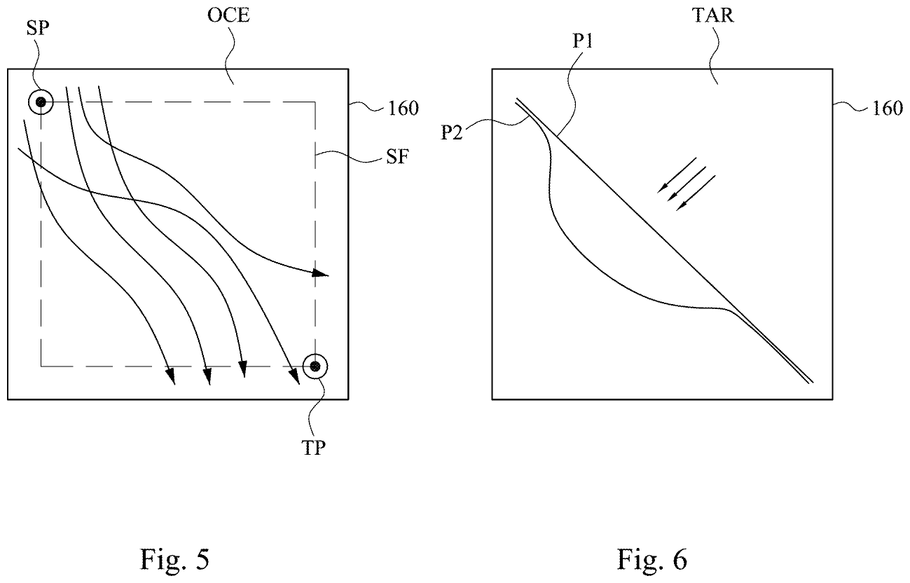

In some embodiments, the processor 140 of the ship navigation system 100 can select some historical lanes leading from a region around the start point SP of the target ship to a region around the terminal point TP of the target ship. For better understandings, referring to FIG. 5. FIG. 5 is a schematic diagram illustrating part of the navigation method according to one embodiment of present disclosure. As shown in FIG. 5, the processor 140 can depict a selection frame SF by using the start point SP of the target ship and the terminal point TP of the target ship as two ends of a diagonal of the selection frame SF. And, the selection frame SF can be displayed on the map of the marine area OCE via the interaction interface 160. In some embodiments, the processor 140 can select some of the historical lanes that passed the selection frame SF, then narrow down to the historical lanes substantially leading from the start point SP to the terminal point TP (i.e. substantially extending from around the upper-left corner to around the lower-right of the selection frame SF).

As mentioned, in some embodiments, the ship navigation system 100 can be communicatively coupled to the ship management server and the weather server to retrieve the historical lanes of the ships in the marine area OCE and the historical environmental data in the marine area OCE. Since the processor 140 of the ship navigation system 100 is provided to navigate the target ship in real-time, the processor 140 can compare the real-time environment with the historical environmental data in order to choose some historical lanes under similar environment. For better understandings, referring to FIG. 6. FIG. 6 is a schematic diagram illustrating a comparison between shipping lanes according to one embodiment of present disclosure. In some embodiments, the interaction interface 160 displays the historical lane P1 and the historical lane P2 of the target area TAR in the marine area OCE. As shown in FIG. 6, the historical lane P1 can be a lane recorded by a ship passing the target area TAR when the wind was calm, and the historical lane P2 can be a lane recorded by a ship passing the target area TAR when the wind blown from the northeast. As shown in FIG. 6, it is apparent that a direction of the historical lane P2 was influenced by the wind from the northeast. It is noted that some environmental conditions other than winds can influence shipping lanes in other possible ways in the marine area OCE.

In some embodiments, after the processor 140 selects some historical lanes substantially leading from somewhere around the start point SP to somewhere around the terminal point TP (as shown in the embodiment of FIG. 4), the processor 140 can do further selection among these historical lanes. In some embodiments, the processor 140 of the ship navigation system 100 can pick parameter sets from both the historical environmental data and the real-time environmental data in order to determine a similarity (or dissimilarity) of the environmental condition. As mentioned, in some embodiments, the historical environmental data comprises the wind directions, the wind speeds, the current directions and the current speeds in the marine area OCE. The processor 140 can select a real-time parameter set from the real-time environmental data and a historical parameter set from the historical environmental data correspondingly to apply such comparison. For example, the wind speed is selected as a parameter in the parameter set. In this case, data corresponding to the wind speeds in the real-time environmental data can be selected into the real-time parameter set, and data corresponding to the wind speeds in the historical environmental data can be selected into the historical parameter set. The processor 140 can apply the comparison between the real-time parameter set and the historical parameter set to get a result.

In some embodiments, the processor 140 can calculate dissimilarities between the real-time parameter set and the historical parameter set. For instance, in a case that the wind directions in marine area OCE are recorded in circular angles (360° in total), the processor 140 can calculate differences between angles of the wind direction extracted in each historical environmental datum and each real-time environmental datum. In some embodiments, in a case that the parameter sets being selected include multiple environmental parameters, the processor 140 can calculate differences between each parameter from the historical environmental data and the real-time environmental data.

In some embodiments, the differences between the environmental parameters can be compared with a predetermined threshold. If a difference between a historical environmental datum and the real-time environmental datum is being determined exceeding the predetermined threshold, the processor 140 can delete a historical lane corresponding to that historical environmental datum. It is noted that the predetermined threshold can be set by the users or be set by the processor 140 according to statistics of the historical environmental data. For example, in some embodiments, if a standard deviation of the wind directions in the historical environmental data is calculated as 2.5 degrees, the processor 140 can calculate a difference between the wind speed corresponding to each historical environmental datum and the wind speed corresponding to each real-time environmental datum. Once a difference of the wind speeds exceeding 2.5 degrees is found, the processor 140 can delete a historical lane corresponding to such difference since it is apparent that this historical environmental datum is not matched to the real-time wind speed in the marine area OCE. In this manner, the processor 140 can apply such selection to generate at least one first candidate lane from the historical lanes. It is noted that, after such selection, the at least one candidate lane being selected from the historical lanes is substantially matched to the real-time environment data in the marine area OCE.

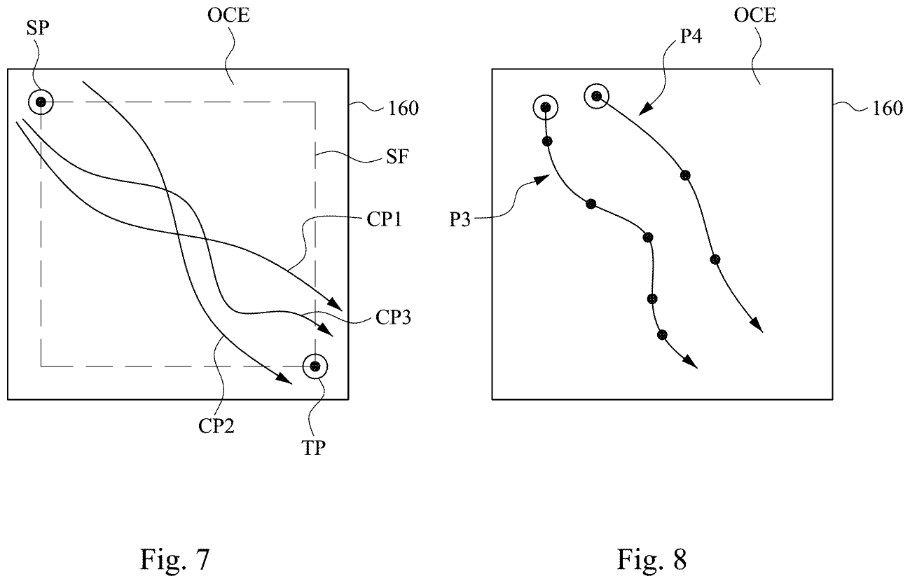

For better understandings, reference is made to FIG. 7. FIG. 7 is a schematic diagram illustrating part of the navigation method according to one embodiment of present disclosure. As mentioned, the processor 140 can select some historical lanes substantially extending from the start point SP to the terminal point TP according to the steps described in the embodiment shown of FIG. 5. It is understood that the lanes shown in FIG. 7 are said at least one first candidate historical lane selected by the processor 140 according to the real-time environmental data. As shown in FIG. 7, the at least one first candidate lane includes three historical lanes, which are the historical lane CP1, CP2, and CP3. These historical lanes are displayed by the interaction interface 160.

It is noted that, in conventional arts, shipping lanes are mostly generated according to the known A* search algorithm. In a navigation system using the A* search algorithm, a plurality of way points in the marine area OCE are searched in a specific order to form a shipping lane. The way points can be understood as some positions (e.g. coordinates determined by longitude and latitude in the marine area OCE) that are available for a ship to sail in the marine area OCE. According to the A* search algorithm, the way points available to the ship are searched and determined one by one. Then, the way points are connected to form the lane for the ship. In addition, some conventional arts are provided to optimize the lanes by reducing some redundant way points after the searching is completed.

For better understandings, referring to FIG. 8. FIG. 8 is a schematic diagram illustrating a comparison between shipping lanes according to one embodiment of present disclosure. As shown in FIG. 8, the interaction interface 160 displays a historical lane P3 and a historical lane P4 in the marine area OCE. It is noted that the historical lane P3 is formed by five way points and the historical lane P4 is formed by two way points (the start point SP and the terminal point TP are not way points). Obviously, the way point number of the historical lane P4 is less than the way point number of the historical lane P3. In some embodiments, the historical lane P3 and the historical lane P4 can be (but not limited to) generated according to aforementioned A* search algorithm or other algorithm recited in following embodiments.

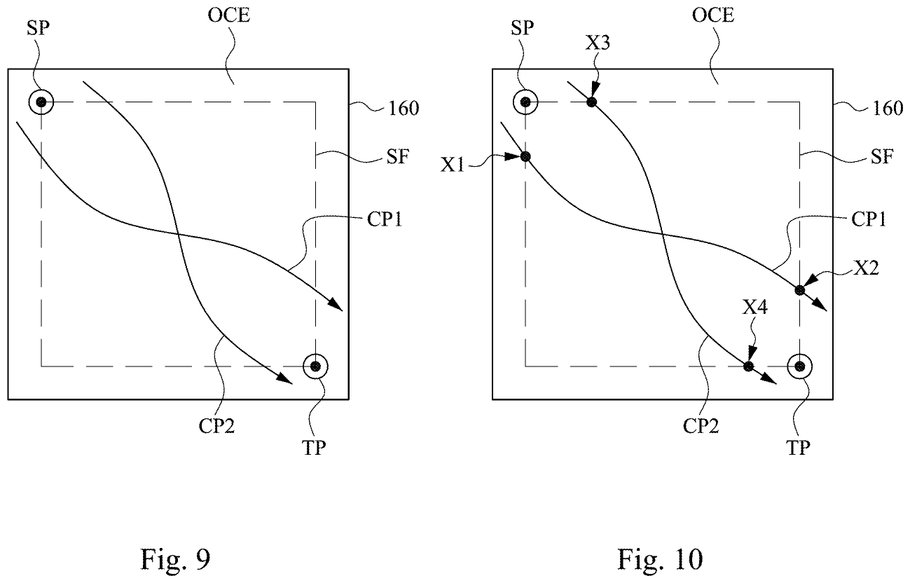

In some embodiments, the processor 140 of the ship navigation system 100 can further apply a selection to the at least one first candidate lanes according to number of way points. For better understandings, reference is made to FIG. 9. FIG. 9 is a schematic diagram illustrating part of the navigation method according to one embodiment of present disclosure. For example, in some embodiments, some of the at least one first candidate lane with the least number of way points can be selected into at least one second candidate lane. The processor 140 can further display the at least one second candidate lane on the map shown by the interaction interface 160. It is noted that, in some embodiments, if it is checked that only one of the at least one first candidate lane has the least number of the way points, the processor 140 can select this first candidate lane to be the at least one second candidate lane. In some embodiments, if it is checked that more than one of the first candidate lanes have the least number of the way points, the processor 140 can select these first candidate lanes to be the at least one second candidate lane.

As shown in the embodiment of FIG. 7, it is assumed that, among the at least one first candidate lane, a number of way points of the historical lane CP3 is the most, and the numbers of way points of the historical lane CP1 and the historical lane historical lane CP2 are equal. Therefore, after the processor 140 done aforesaid selection, the historical lane CP1 and the historical lane CP2 can be selected into the at least one second candidate lanes, as shown in FIG. 9.

In some embodiments, the processor 140 of the ship navigation system 100 can further check the at least one second candidate lane according to distances. For better understandings, referring to FIG. 10. FIG. 10 is a schematic diagram illustrating part of the navigation method according to one embodiment of present disclosure. For instance, in some embodiments, the processor 140 can determine one of the at least one second candidate lane having the shortest distance with respect to the start point SP and the terminal point TP of the target ship to be a target lane. The target lane can be shown on the interaction interface 160 as well. As shown in FIG. 10, the historical lane CP1 and the selection frame SF have two intersections. An intersection X1 is located around the start point SP of the target ship, and another intersection X2 is located around the terminal point TP of the target ship.

Similarly, two intersections of the historical lane CP2 and the selection frame SF are shown in FIG. 10. An intersection X3 is located around the start point SP of the target ship, and another intersection X4 is located around the terminal point TP of the target ship. To determine the relative distance from the historical lane CP1 to the start point SP and the terminal point TP, the processor 140 can sum up a distance between the start point SP and the intersection X1 and a distance between the terminal point TP and the intersection X2. In the same manner, the processor 140 can sum up a distance between the start point SP and the intersection X3 and a distance between the terminal point TP and the intersection X4 in order to get the relative distance from the historical lane CP2 to the start point SP and the terminal point TP. According to these relative distances, the processor 140 can select the historical lane CP2 as the target lane since it is relatively closed to the start point SP of the target ship and the terminal point TP of the target ship.

In step S250: generating a recommended lane for the target ship in the marine area by connecting the start point and the terminal point with the target lane.

In some embodiments, after the processor 140 determines the target lane from the at least one second candidate lanes, the target lane can be connected to the start point SP and the terminal point TP of the target ship to generate a recommended lane for the target ship in the marine area OCE. In one embodiment, the processor 140 can generate the recommended lane according to a specific search algorithm. In some embodiments, the specific search algorithm can be an improved A* search algorithm for guiding the target ship from the start point SP to the terminal point TP via the target lane.

In some embodiments, locations in the marine area OCE can be represented as nodes with longitudes and latitudes. A cost function of the specific search algorithm can be used to find a cost of each node in the marine area OCE. Through the specific search algorithm, several way points can be found by lowering a sum of costs of the nodes being searched to a minimal cost. A lane formed by these way points can therefore be determined. The weight function is represented as:

f(n)=g(n)+h(n)+w(n).

In the cost function, g(n) is a function for calculating a real distance from a node to the start point SP of the target ship in the marine area OCE. The result of g(n) can be obtained by summing a distance from a parent node of the node to the start point SP and an Euclidean distance from the parent node to the node. In the cost function, h(n) is a function for calculating an estimated distance from node to the terminal point TP of the target ship in the marine area OCE. The result of h(n) can be obtained by calculating a Manhattan distance from the node to the target ship. In the cost function, w(n) is a function for calculating a weight of the node with respect to the target lane (i.e. the historical lane CP2 in above embodiment). The result of w(n) can be obtained by calculating a shortest distance from the node to the target lane. It is noted that, in a search according to the specific search algorithm, the result of w(n) can be gradually reduced.

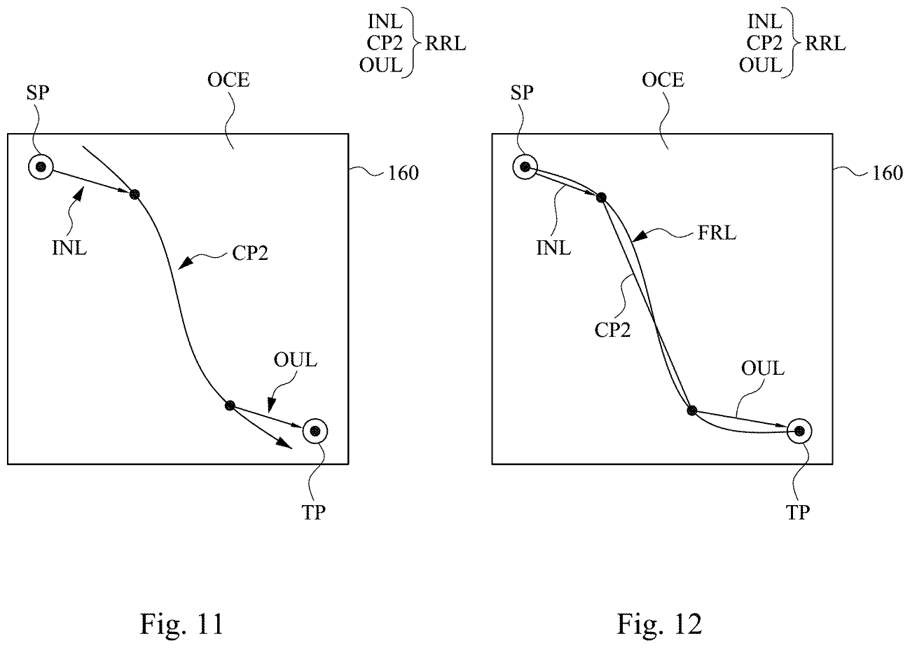

For better understandings, reference is made to FIG. 11. FIG. 11 is a schematic diagram illustrating part of the navigation method according to one embodiment of present disclosure. For instance, as shown in FIG. 11, in some embodiments, after the processor 140 selects the historical lane CP2 to be the target lane, the processor 140 can further determine a lead-in lane INL and a lead-out lane OUL according to above specific search algorithm. The lead-in lane INL and the lead-out lane OUL can be displayed on the map shown by the interaction interface 160. As shown in FIG. 11, the lead-in lane INL is extending from the start point SP of the target ship to the historical lane CP2 and the lead-out lane OUL is extending from the historical lane CP2 to the terminal point TP of the target ship.

In some embodiments, the processor 140 can further apply a curve fitting process to these lanes to gain the recommended lanes. For example, in some embodiments, after the processor 140 gets the lead-in lane INL and the lead-out lane OUL, the processor 140 can connect the lead-in lane INL to the historical lane CP2 and connect the historical lane CP2 to the lead-out lane OUL. Then, redundant lanes before the lead-in intersection and after the lead-out intersection on the historical lane CP2 can be deleted. In this way, the processor 140 can generate a raw recommended lane RRL. The curve fitting process can be applied to the way points on the raw recommended lane RRL. For better understandings, referring to FIG. 12. FIG. 12 is a schematic diagram illustrating part of the navigation method according to one embodiment of present disclosure. As shown in FIG. 12, the curve fitting process executed by the processor 140 aims to modify the raw recommended lane RRL into a final recommended lane FRL which is smoother. The final recommended lane FRL can be displayed on the map shown by the interaction interface 160. In some embodiments, the curve fitting process is based on a method of least squares algorithm.

In step S260: receiving a real-time position of a plurality of surrounding ships and a direction of the plurality of surrounding ships, then estimating whether the recommended lane being blocked by the plurality of surrounding ships according to the real-time position and the direction of the plurality of surrounding ships, and in response to the recommended lane being estimated to be blocked by the plurality of surrounding ships, modifying the recommended lane to a modified lane.

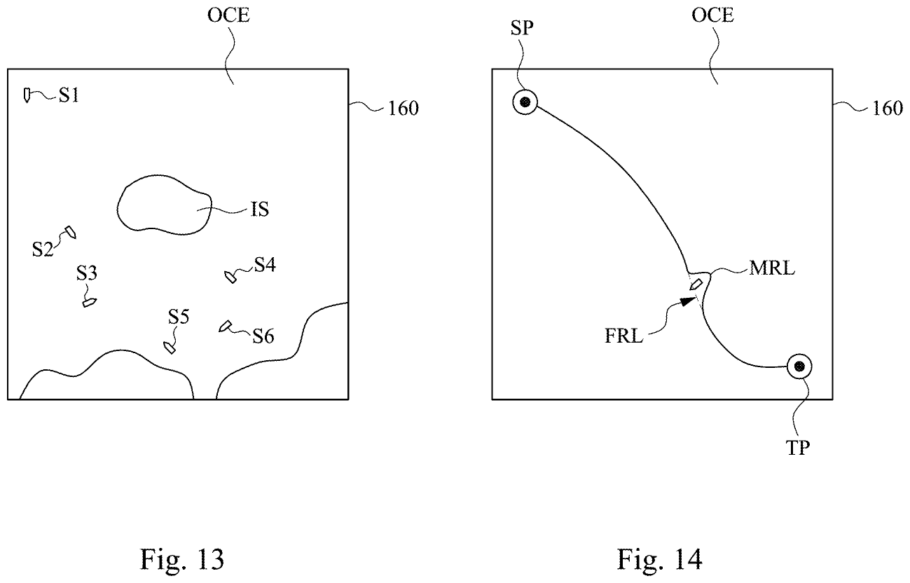

As mentioned, in some embodiments, the ship navigation system 100 can be communicatively coupled to the ship management server to receive data of other ships in the marine area OCE. In some embodiments, when the processor 140 of the ship navigation system 100 receives the real-time environmental data and data of other ships in the marine area OCE, the processor 140 can send electric signals carrying the data to the interaction interface 160 and the interaction interface 160 can display the data via the output interface. For example, the interaction interface 160 can show mentioned data on the map of the marine area OCE. For better understandings, reference is made to FIG. 13. FIG. 13 is a schematic diagram illustrating part of the navigation method according to one embodiment of present disclosure. In some embodiments, in the map shown by the interaction interface 160, six ships S1-S6 are located around the target ship in the marine area OCE.

In some embodiments, the users can select some of the six ships S1-S6 in the marine area OCE via the input interface of the interaction interface 160, and the interaction interface 160 can show data of these six ships S1-S6 in some information blocks. In some embodiments, the users can select some locations (coordinates determined by longitudes and latitudes) in the marine area OCE, and the interaction interface 160 can show real-time environmental data corresponding to these locations in some information blocks.

In some embodiments, the ship navigation system 100 can be communicatively coupled to the ship management server to receive data of other ships in the marine area OCE, especially the real-time positions, directions and speeds of these ships. In some embodiments, according to the real-time positions, directions and speeds of these ships, the processor 140 of the ship navigation system 100 can estimate whether the final recommended lane FRL can be blocked by some of these ships. In some embodiments, the processor 140 can generate a safety circle of a ship by extending a safety distance (e.g. according to length of the ship) from its real-time position. Along with the direction and the speed of the ship, the safety circle can depict an obstacle zone corresponding to that ship in the marine area OCE.

In some embodiments, after the processor 140 depicts the obstacle zones corresponding to other ships in the marine area OCE, it can be estimated if the final recommended lane FRL may pass these obstacle zones. The estimation can be established according to algorithms built on Kalman Filter, particle filter, or structured tracking with kernel, etc. If it is determined that the recommended lane may pass these obstacle zones, collisions between the target ship and some of these ships may happened. The processor 140 is configured to modify the recommended lane to avoid such collisions. For better understandings, referring to FIG. 14. FIG. 14 is a schematic diagram illustrating part of the navigation method according to one embodiment of present disclosure. As shown in FIG. 14, in some embodiments, when the processor 140 determines that the final recommended lane FRL may be blocked by another ship in the marine area OCE, the processor 140 can modify the recommended lane to dodge said ship. As shown in FIG. 14, a modified recommended lane MRL is generated by the processor 140. The modified recommended lane MRL is shown on the map displayed by the interaction interface 160.

In some embodiments, when the processor 140 of the ship navigation system 100 generates the modified recommended lane MRL according to the ship navigation method 200, the processor 140 can navigate the target ship according to the modified recommended lane MRL. Thus, the target ship should be driven in the marine area OCE along the modified recommended lane MRL. However, it is noted that the ship navigation method 200 can be operated in a dynamic mode. When the target ship is sailing in the marine area OCE along the modified recommended lane MRL, it is possible that the ship navigation method 200 being executed for several times according to the environment and other ships in the marine area OCE.

It is noted that, basically, the interaction interface 160 shows each steps of the ship navigation method 200 described in the embodiments of FIG. 3-14. However, the embodiments are provided for exemplary purposes. It is understood that, in some embodiments, the ship navigation method 200 can be a back-end process executed by the processor 140. In this case, it is not necessary to show the steps to the users via the interaction interface 160.

According to forgoing embodiments, present disclosure provides the ship navigation system and the ship navigation method. Based on such system and method, some idea lanes matched to current environment can be selected from the historical lanes. The target ship can be navigated from the start point to the terminal point via the selected lane. Moreover, the ship navigation system and the ship navigation method can be operated dynamically to adapt moves of other ships. In this way, accidents between ships can be avoided.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A ship navigation system, comprising:
a memory configured to store at least one instruction; and
a processor, coupled to the memory, being configured to access the at least one instruction to perform following operations:
receiving a start point of a target ship and a terminal point of the target ship in a marine area;
receiving real-time environmental data of the marine area, a plurality of historical lanes in the marine area and historical environmental data corresponding to the plurality of historical lanes;
comparing the historical environmental data with the real-time environmental data to select a target lane from the historical lanes, wherein the target lane is leading from a location near the start point to a location near the terminal point; and
connecting the start point and the terminal point with the target lane to generate an recommended lane for the target ship in the marine area.

2. The ship navigation system of claim 1, wherein the processor is further configured to access the at least one instruction to perform following operations:
receiving a real-time position of a plurality of surrounding ships and a direction of the plurality of surrounding ships;
estimating whether the recommended lane is blocked by the plurality of surrounding ships according to the real-time position and the direction of the plurality of surrounding ships; and
in response to the recommended lane being estimated to be blocked by the plurality of surrounding ships, modifying the recommended lane to a modified lane.

3. The ship navigation system of claim 2, wherein the operation of estimating whether the recommended lane is blocked by the plurality of surrounding ships according to the real-time position and the direction of the plurality of surrounding ships further comprising:
extending a safety distance from the real-time position of the plurality of surrounding ships, in order to generate a plurality of obstacle zones according to the directions of the plurality of surrounding ships;
estimating whether the recommended lane encounters the plurality of obstacle zones; and
in response to the recommended lane being estimated to encounter the plurality of obstacle zones, determining that the recommended lane is blocked by the plurality of surrounding ships.

4. The ship navigation system of claim 1, wherein the operation of comparing the historical environmental data with the real-time environmental data to select the target lane from the historical lanes further comprising:
calculating a plurality of difference levels between the historical environmental data corresponding to each of the historical lanes and the real-time environmental data, in order to select at least one first candidate lane from the historical lanes according to the plurality of difference levels; and
selecting the target lane from the at least one first candidate lane.

5. The ship navigation system of claim 4, wherein the operation of the plurality of difference levels to select the at least one first candidate lane further comprising:
selecting a first lane from the historical lanes;
obtaining a historical parameter set from the historical environmental data corresponding to the first lane and obtaining a real-time parameter set from the real-time environmental data corresponding to the historical parameter set;
calculating a difference between the real-time parameter set and the historical parameter set corresponding to the first lane;
determining whether the difference corresponding to the first lane exceeds a predetermined threshold;
if the difference corresponding to the first lane is determined to exceed the predetermined threshold, removing the first lane from the historical lanes; and
if the difference corresponding to the first lane is determined to not exceed the predetermined threshold, selecting the first lane to be the at least one first candidate lane.

6. The ship navigation system of claim 4, wherein the processor selecting the target lane from the at least one first candidate lane further comprising:
counting a plurality of way points corresponding to each of the at least one first candidate lane;
selecting the at least one first candidate lane having the least way points and determining whether a number of the at least one first candidate lane being selected exceeds one; and
if the number of the at least one first candidate lane being selected is determined not to exceed one, confirming that the at least one first candidate lane having the least way points to be selected as the target lane.

7. The ship navigation system of claim 6, wherein if the number of the at least one first candidate lane being selected is determined to exceed one, the processor is further configured to access the at least one instruction to perform the following:
selecting the at least one first candidate lane having the least way points to be a plurality of second candidate lanes;
depicting a selection frame in the marine area, wherein the start point of the target ship and the terminal point of the target ship are located at two corners of the selection frame respectively;
targeting a first intersection and a second intersection that each of the plurality of second candidate lanes crossing the selection frame;
calculating a first distance between the first intersection and the start point and a second distance between the second intersection and the terminal point;
calculating a sum of the first distance and the second distance corresponding to each of the plurality of second candidate lanes; and
selecting a second lane from the plurality of second candidate lanes, wherein the sum of the second lane is the least among the plurality of second candidate lanes.

8. The ship navigation system of claim 5, wherein the historical parameter set comprises at least one of a wind direction, a wind speed, a current direction and a current speed, and the real-time parameter set comprises at least one of the wind direction, the wind speed, the current direction and the current speed.

9. The ship navigation system of claim 1, wherein the operation of generating the recommended lane for the target ship in the marine area further comprising:
connecting a lead-in lane from the start point to the target lane;
connecting a lead-out lane from the target lane to the terminal point; and
applying a curve fitting process to the lead-in lane, the lead-out lane and the target lane to generate the recommended lane.

10. A ship navigation method, performed by a processor according to at least one instruction accessed from a memory, the ship navigation method comprising:
receiving a start point of a target ship and a terminal point of the target ship in a marine area;
receiving a real-time environmental data of the marine area, a plurality of historical lanes in the marine area and a historical environmental data corresponding to the plurality of historical lanes;
comparing the historical environmental data with the real-time environmental data to select a target lane from the historical lanes, wherein the target lane is leading from a location near the start point to a location near the terminal point; and
connecting the start point and the terminal point with the target lane to generate an recommended lane for the target ship in the marine area by connecting the start point and the terminal point with the target lane.

11. The ship navigation method of claim 10, further comprising:
receiving a real-time position of a plurality of surrounding ships and a direction of the plurality of surrounding ships;
estimating whether the recommended lane is blocked by the plurality of surrounding ships according to the real-time position and the direction of the plurality of surrounding ships; and
in response to the recommended lane being estimated to be blocked by the plurality of surrounding ships, modifying the recommended lane to a modified lane.

12. The ship navigation method of claim 11, wherein estimating whether the recommended lane is blocked by the plurality of surrounding ships according to the real-time position and the direction of the plurality of surrounding ships further comprising:
extending a safety distance from the real-time positions of the plurality of surrounding ships, in order to generate a plurality of obstacle zones according to the directions of the plurality of surrounding ships;
estimating whether the recommended lane encounters the plurality of obstacle zones; and
in response to the recommended lane being estimated to encounter the plurality of obstacle zones, determining that the recommended lane is blocked by the plurality of surrounding ships.

13. A ship navigation method of claim 10, wherein the processor comparing the historical environmental data with the real-time environmental data to select the target lane from the historical lanes further comprising:
calculating a plurality of difference levels between the historical environmental data corresponding to each of the historical lanes and the real-time environmental data, in order to select at least one first candidate lane from the historical lanes according to the plurality of difference levels; and
selecting the target lane from the at least one first candidate lane.

14. The ship navigation method of claim 13, wherein the processor calculating the plurality of difference levels to select the at least one first candidate lane further comprising:
selecting a first lane from the historical lanes;
obtaining a historical parameter set from the historical environmental data corresponding to the first lane and obtaining a real-time parameter set from the real-time environmental data corresponding to the historical parameter set;
calculating a difference between the real-time parameter set and the historical parameter set corresponding to the first lane;
determining whether the difference corresponding to the first lane exceeds a predetermined threshold;
if the difference corresponding to the first lane is determined to exceed the predetermined threshold, removing the first lane from the historical lanes; and
if the difference corresponding to the first lane is determined to not exceed the predetermined threshold, selecting the first lane to be the at least one first candidate lane.

15. The ship navigation method of claim 13, wherein the processor selecting the target lane from the at least one first candidate lane further comprising:
counting a plurality of way points corresponding to each of the at least one first candidate lane;
selecting the at least one first candidate lane having the least way points and determining whether a number of the at least one first candidate lane being selected exceeds one; and
if the number of the at least one first candidate lane being selected is determined not to be exceed one, confirming that the at least one first candidate lane having the least way points to be selected as the target lane.

16. The ship navigation method of claim 15, wherein if the number of the at least one first candidate lane being selected is determined to exceed one, the processor further performs the following:
selecting the at least one first candidate lane having the least way points to be a plurality of second candidate lanes;
depicting a selection frame in the marine area, wherein the start point of the target ship and the terminal point of the target ship are located at two corners of the selection frame respectively;
targeting a first intersection and a second intersection that each of the plurality of second candidate lanes crossing the selection frame;
calculating a first distance between the first intersection and the start point and a second distance between the second intersection and the terminal point;
calculating a sum of the first distance and the second distance corresponding to each of the plurality of second candidate lanes; and
selecting a second lane from the plurality of second candidate lanes, wherein the sum of the second lane is the least among the plurality of second candidate lanes.

17. The ship navigation method of claim 14, wherein the historical parameter set comprises at least one of a wind direction, a wind speed, a current direction and a current speed, and the real-time parameter set comprises at least one of the wind direction, the wind speed, the current direction and the current speed.

18. The ship navigation method of claim 10, wherein the processor generating the recommended lane for the target ship in the marine area further comprising:
connecting a lead-in lane from the start point to the target lane;
connecting a lead-out lane from the target lane to the terminal point; and
applying a curve fitting process to the lead-in lane, the lead-out lane and the target lane to generate the recommended lane.
